(19) United States
(12) Patent Application Publication
(10) Pub. No.: US 2005/0104854 A1
(43) Pub. Date: May 19, 2005

(54) Multi-mode computer pointer

(76) Inventors: Chun-Nan Su, Taipei (TW); Chen-Ming Chang, Taipei (TW); Chih-Feng Chien, Keelung (TW)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/938,059

(22) Filed: Sep. 10, 2004

(30) Foreign Application Priority Data
Nov. 17, 2003 (TW) 092132366

(51) Int. Cl. G09G 5/08

(52) U.S. Cl. 345/163

(57) ABSTRACT

A multi-mode computer pointer includes a main body, a function switch disposed on the main body and triggered to switch the computer pointer between a first mode and a second mode, and a command generator in communication with the function switch and a computer, triggered in a manner to generate a cursor control command to the computer in the first mode and triggered in the same manner to generate a non-cursor control command to the computer in the second mode. The non-cursor control mode, for example, is for controlling windows media player.

### FIELD OF THE INVENTION

The present invention relates to a computer pointer, and more particularly to a multi-mode computer pointer capable of performing both frame/cursor and media-player control.

### BACKGROUND OF THE INVENTION

Computer pointers such as mouse pointers or trackball pointers are widely used for frame/cursor control aside from keyboard devices. A computer pointer typically includes a plurality of click buttons and a scroll wheel, as shown in FIG. 1A, which are previously programmed to perform specified functions. For example, a left button 11 is programmed to make selection or enter command, a right button 12 is programmed to invoke context menu, and the scroll wheel 13 is used to effortlessly navigate continuous pages without operating on the on-screen scroll bar.

Conventionally, when for example a Microsoft® windows media player application program is working to display images or films, the user has to move the cursor with the computer pointer to the position of the desired functional icon shown on the screen, and then click the button 11 on the selected icon differentially to adjust the audio/video effect. For example, as shown in FIG. 1B, by moving the cursor arrow to the volume icon 141 on the screen, and push on and drag that icon 141 rightward, the volume will increasingly change. For some media player application programs, the user has to click the button 12 first to show the control menu 14 as exemplified in FIG. 1C, and then use the button 11 to control the audio-video effects in a similar manner as mentioned above. For example, by moving the cursor arrow to the pause button 142 on the screen and click the button 11 on it, the played film will become paused.

Before the video/audio effects of the images or film have satisfied the user, the user is likely to frequently recall the control panel to the screen to make adjustment. Thereafter, the user still needs to operate on the control panel occasionally to perform various functions such as play, pause, stop, track forward, track backward, volume up, volume down, mute, etc. In other words, the user has to frequently move the computer pointer and operate the buttons thereof. Further, the displayed control panel possibly overlays the images or film being played. It somewhat bothers the user. Although a real media-player control panel 21 consists of a plurality of functional keys has been provided on a keyboard device 20 to specifically perform media-player control, as shown in FIG. 2, the real media-player control panel, of course, occupies a certain space of the keyboard device. For some computer systems such as laptop computers or at limited working location, only the use of small keyboard device is proper and thus it is difficult to additionally provide the real media-player control panel. Under this circumstance, the media-player control is complicated.

### SUMMARY OF THE INVENTION

The present invention provides a multi-mode optical computer pointer capable of performing both frame/cursor and media-player control to simplify the media-player control.

The present invention relates to a multi-mode computer pointer, which comprises a main body; a function switch disposed on the main body and triggered to switch the computer pointer between a first mode and a second mode; and a command generator in communication with the function switch and a computer, triggered in a manner to generate a frame/cursor control command to the computer in the first mode and triggered in the same manner to generate a media-player control command to the computer in the second mode.

In an embodiment, the function switch is a two-phase button pushed to generate a media-playing mode signal to have the computer pointer enter the second mode and further pushed to suspend the media-playing mode signal to have the computer pointer return to the first mode.

In an embodiment, a control signal is transmitted to the computer in the first mode to convey the frame/cursor control command, and the control signal is transmitted to the computer along with the media-playing mode signal in the second mode to convey the media-player control command.

In an embodiment, the command generator communicates with the computer via a windows interface, and the first and second commands are HID (human interface device) commands.

In an embodiment, the command generator comprises: a plurality of control buttons disposed on the main body for generating control signals in response to the manipulation of the user; and a wireless signal transmitter disposed on the main body for wirelessly transmitting the control signals to a wireless signal receiver of the computer to perform frame/cursor control in the first mode and wirelessly transmitting the control signals to the computer to perform media-player control in the second mode. The wireless signal transmitter further transmits a media-playing mode signal along with the control signals to the wireless signal receiver of the computer in the second mode. The wireless signal receiver coverts the control signals into the cursor control command and converts the media-playing mode signal and the control signals into the non-cursor control command.

The multi-mode computer pointer according to the present invention, for example, is a mouse pointer or a trackball pointer.

The present invention also relates to a multi-mode computer pointer, which comprises a main body; a function switch disposed on the main body and triggered to switch the computer pointer between a first mode and a second mode; and a command generator in communication with the function switch and a computer, triggered in a manner to generate a cursor control command to the computer in the first mode and triggered in the same manner to generate a non-cursor control command to the computer in the second mode.

In an embodiment, the non-cursor control command is for controlling an application program. The application program, for example, is Microsoft® windows media player, Microsoft® Office, Microsoft® Internet Explorer or Microsoft® Outlook application programs.

The present invention further relates to a multi-mode computer mouse pointer, which comprises a main body to be held by a user; a two-phase function switch arranged on the main body, triggered to generate a mode-switching signal and further triggered to suspend the mode-switching signal; and a plurality of control buttons arranged on the main body and clicked to generate control signals. The control signals are converted into a first control command with the mode-switching signal, and converted into a second control command without the mode-switching signal.

In an embodiment, the first control command is a media-player control command and the second control command is a frame/cursor control command.

Preferably, a plurality of icons are provided on the control buttons for identifying respective functions of the control buttons for media-player control.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a schematic perspective diagram showing a conventional mouse pointer;

FIGS. 1B and 1C are schematic diagrams showing two conventional media-player control panels;

FIG. 2 is a schematic diagram showing a keyboard device provided with media-player control keys;

FIG. 3A is a schematic diagram showing a mouse pointer according to an embodiment of the present invention;

FIG. 3B is an flowchart schematically showing the conversion of the commands to be transmitted from the mouse pointer of FIG. 3A to the personal computer;

FIG. 4 is a schematic top view of another mouse pointer according to another embodiment of the present invention; and

FIG. 5 is a block diagram showing the transmission of cursor or non-cursor control signals to the computer according to the present invention.

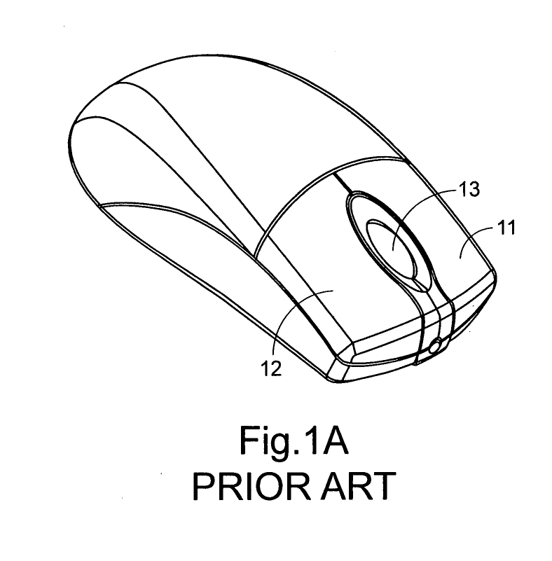

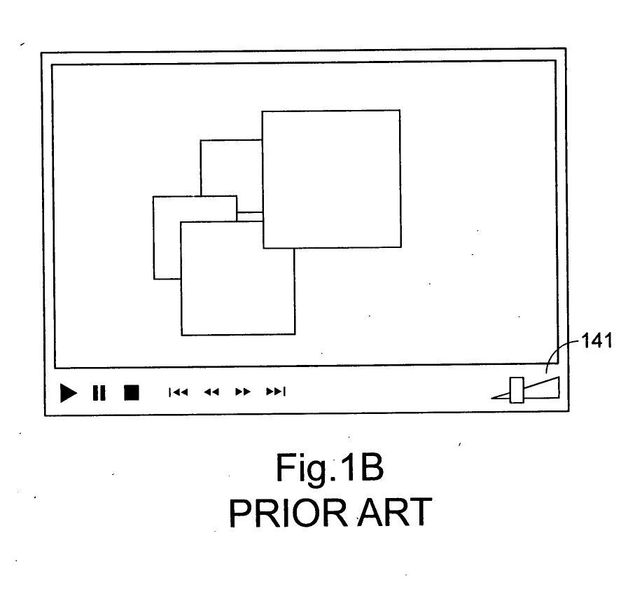

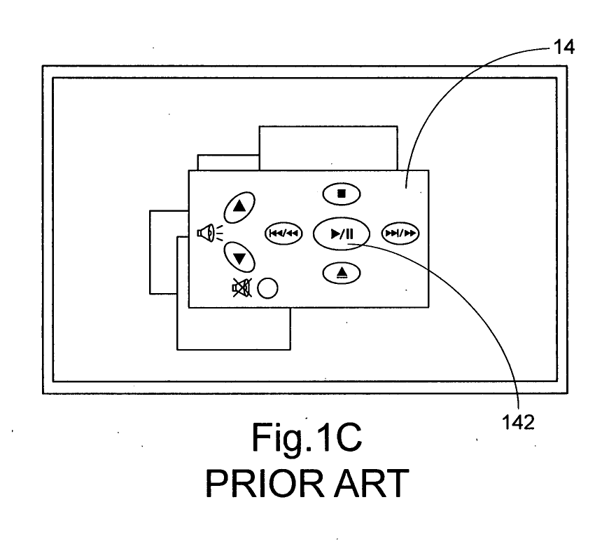

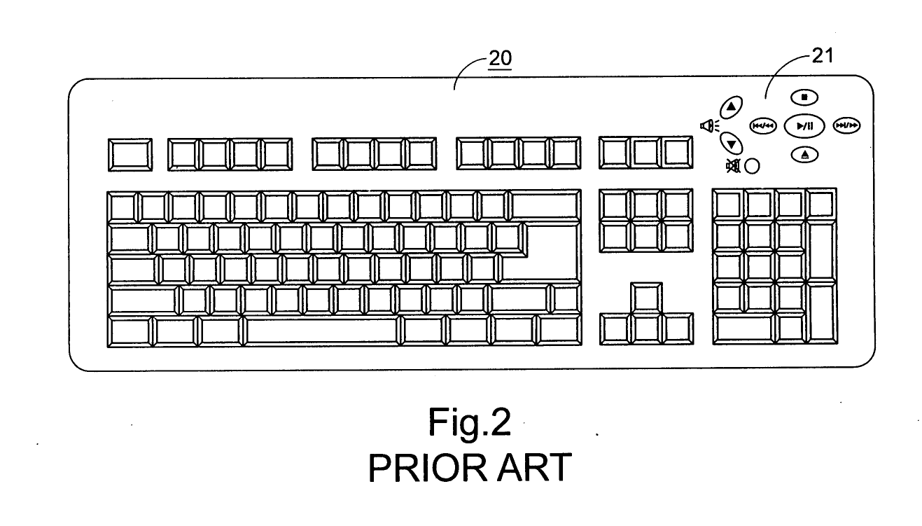

### DETAILED DESCRIPTION OF THE PREFERRED EMBODIMENT

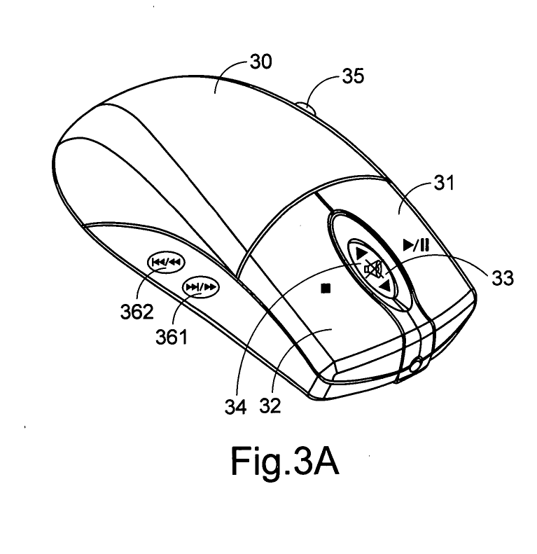

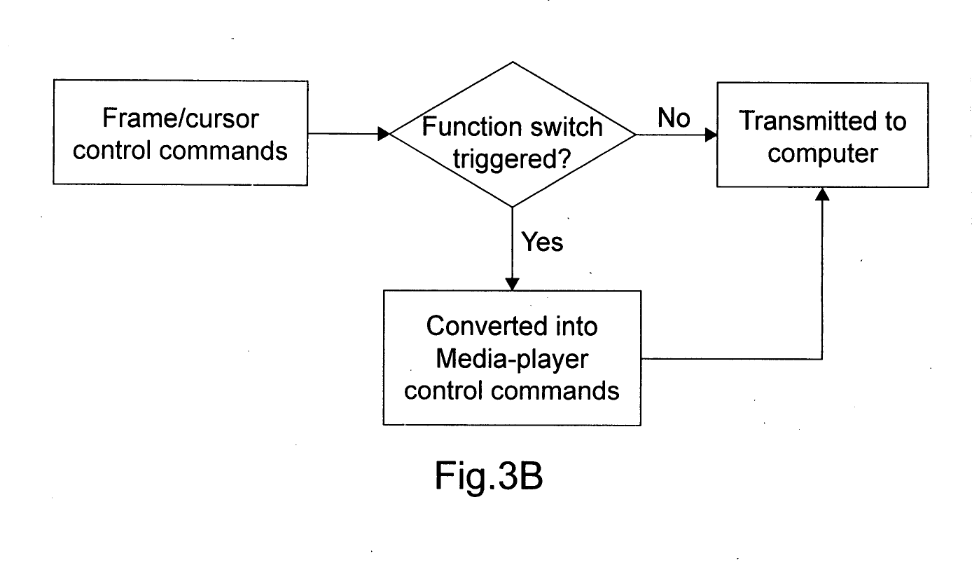

Hereinafter, a multi-mode computer according to a first embodiment of the present invention is illustrated with reference to a mouse pointer of FIG. 3. The mouse pointer, like typical mouse pointers currently used, includes a main body 30, a left click button 31, a right click button 32 and a scroll wheel 33. The scroll wheel 33, in addition to rotation, can also serve as a middle click button 34. These control buttons and scroll wheel are arranged on the main body 30 and pre-programmed to be imparted thereto specified functions. For example, the left click button 31 is used to make selection or enter command, the right click button 32 is used to invoke menu, the scroll wheel 33 is rotated to navigate continuous pages, and the activation of the middle click button automatically runs pages without rotating the scroll wheel 33. The main body 30 accommodates therein photoelectric devices (not shown) for determining the shift level made by the user so as to reflect corresponding cursor or frame change on the computer display, thereby achieving the purpose of frame/cursor control. In order to provide further control functions in addition to frame/cursor control, the mouse pointer of FIG. 3 according to the present invention further includes a function switch 35 arranged on the main body 30 and optionally one or more additional control buttons, e.g. the buttons 361 and 362. The arrangement of the existent and additional control buttons on the main body 30 depends on practical and esthetical designs.

The mouse pointer exemplified in FIG. 3A is a dual-mode mouse pointer capable of performing frame/cursor and media-player control and the function switch 35 is a two-phase button. Assuming that the preset mode of the mouse pointer is the frame/cursor control mode, the mouse pointer can be switched into a non-frame/non-cursor control mode, i.e. the media-player control mode in this example, by triggering the function switch 35. By pushing the function switch 35, a media-playing mode signal is generated to have the mouse pointer enter the media-player control mode, and when the function switch 35 is pushed again, the media-playing mode signal is suspended to have the computer pointer return to the frame/cursor control mode. Once accompanied by the media-playing mode signal, the control signals issued in response to the triggered buttons, which are originally transmitted to the computer to convey frame/cursor control commands, become conveying media-player control commands. For example, the left click button 31 triggered in the media-player control mode becomes a “PLAY/PAUSE” key of the windows media player. Likewise, the right click button 32 becomes a “STOP” key; the scroll wheel 33 becomes a “VOLUME” key; the middle click button 34 becomes a “MUTE” key; the additional control key 361 is a “FORWARD” key; and the additional control key 362 is a “BACKWARD” key. Further, the buttons can be optionally provided with printed icons as illustrated for facilitating identification of the additional functions.

FIG. 3B summarizes the conversion of the frame/cursor control commands to the media-player control commands in the mouse pointer of FIG. 3A. Whether the function switch 35 is triggered is discriminated with a built-in software. If the function switch 35 is determined to have been triggered, the commands transmitted to the computer via the signal transmitter are media-player control commands. Otherwise, it is general frame/cursor control commands transmitted to the computer via the signal transmitter.

The non-frame/non-cursor control able to be performed according to the present invention can be various. As long as the control buttons are well pre-programmed, any application program control can be performed under the present concept. For example, the application program can be Microsoft® windows media player, Microsoft® Office, Microsoft® Internet Explorer or Microsoft® Outlook. For example, the functional items associated with the Microsoft® windows media player includes play, pause, stop, track forward, track backward, volume up, volume down, mute, etc; the functional items associated with Microsoft® Office includes copy, cut, paste, undo, redo, zoom in, zoom out, etc.; the functional items associated with Microsoft® Internet Explorer includes home, stop, bookmarks, search, refresh, etc; and the functional items associated with Microsoft® Outlook includes address book, new, send, forward, reply, etc.

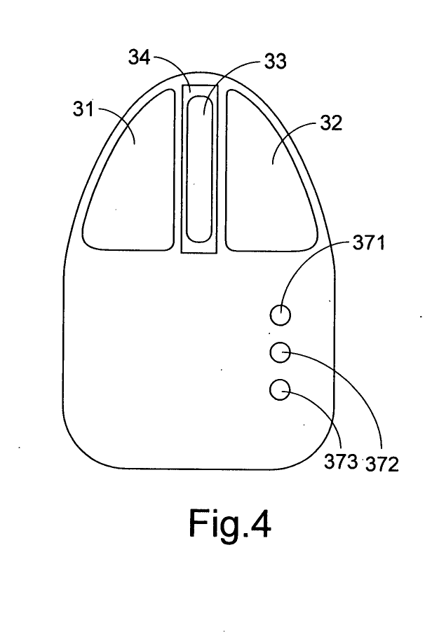

FIG. 4 schematically shows another feasible arrangement, wherein a plurality of function switches 371, 372 and 373 are provided. Of course, all the control buttons as well as the function switches are preferably arranged at positions easy to be manipulated by the user. The function switches 371, 372 and 373 can be differentially triggered to issue respective application-program mode signals. Accordingly, the control signals issued in response to the triggered buttons and accompanied by one of the application-program mode signals convey application-program control commands, e.g. HID for AP control code. For example, when the function switch 371 is triggered, the Microsoft® Office control mode is entered. Then, the left click button 31 becomes a “COPY” key; the right click button 32 becomes a “PASTE” key; the scroll wheel 33 becomes a “ZOOM” key; and the middle click button 34 becomes a “CUT” key. When the function switch 372 is triggered, the Microsoft® Internet Explorer control mode is entered. Then, the left click button 31 becomes a “HOME” key; the right click button 32 becomes a “STOP” key; the scroll wheel 33 becomes a “SEARCH” key when scrolled up and a “REFRESH” key when scrolled down; and the middle click button 34 becomes a “BOOKMARKS” key. When the function switch 373 is triggered, the Microsoft® Outlook control mode is entered. Then, the left click button 31 becomes a “NEW” key; the right click button 32 becomes a “ADDRESS BOOK” key; the scroll wheel 33 becomes a “FORWARD” key when scrolled up and a “REPLY” key when scrolled down; and the middle click button 34 becomes a “SEND” key.

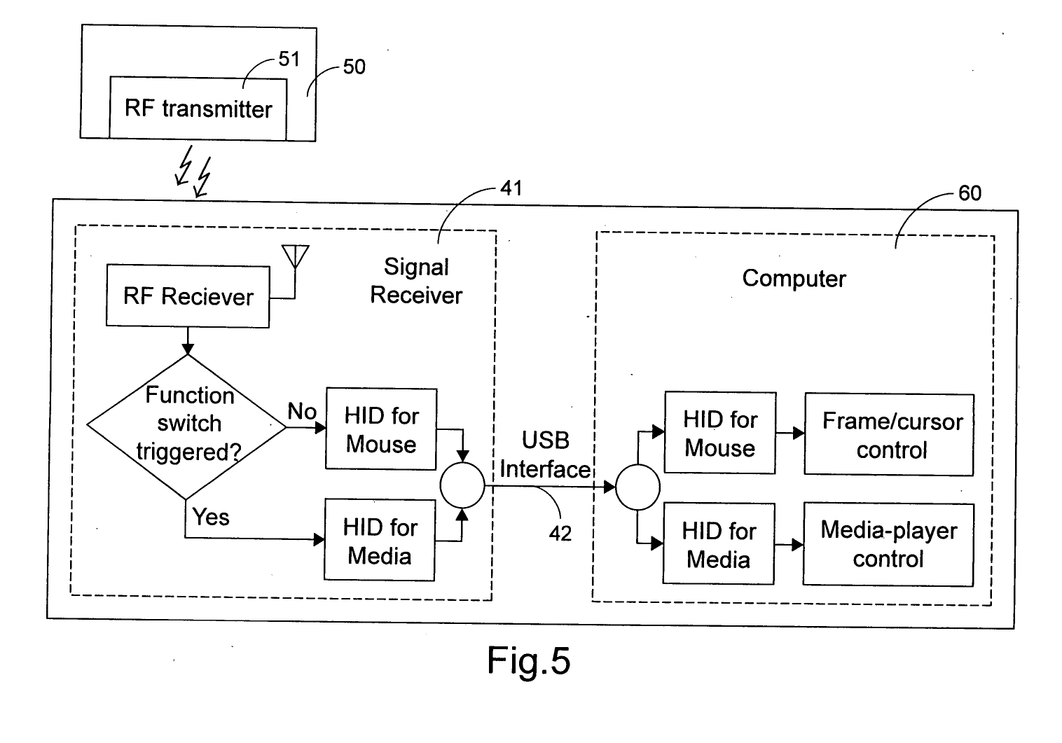

The control signals and media-playing mode and application-program mode signals can be transmitted to the computer via cable transmission or wireless transmission such as Radio Frequency (RF) transmission. For example, as shown in the block diagram of FIG. 5, the computer pointer 50 can be a wireless mouse pointer as exemplified above. The wireless computer pointer 50 comprises a wireless signal transmitter 51. The wireless signal transmitter 51 converts the control signals into Human Interface Device (HID) for Mouse commands identifiable by the windows interface. The HID for Mouse commands wirelessly transmitted out by the wireless transmitter 51 and received by the wireless receiver 41 in communication with the computer system 60 are then transmitted to the computer system 60 via a USB interface 42. Accordingly, the cursor control is performed. On the other hand, when the media-playing or application-program mode signal is wirelessly transmitted along with the control signals, the state of the computer pointer 50 is changed. In practice, the media-playing or application-program mode signal can be a one-bit status flag, i.e. bit “0” or bit “1”, depending on the triggered/untriggered state of the function switch. For example, when the status flag is changed from the bit “0” to bit “1”, it means the function switch is triggered and the HID for Media or HID for AP Control Code commands other than the HID for Mouse commands are transmitted between the wireless transmitter 51 and the wireless receiver 41. The HID for Media or HID for AP Control Code commands are then transmitted to the computer system 60 via the USB interface 42. Accordingly, the non-cursor control such as media-player control or application-program control is performed.

The invention has been described in terms of what is presently considered to be the most practical and preferred embodiments, and need not be limited to the disclosed embodiment. For example, in addition to a mouse pointer, a trackball pointer is also a popular computer pointer which can be modified according to the present invention to function as a multi-mode computer pointer. Further, the function switch or switches as described above can be modified by those skilled in the art and replaced with any other suitable hardware or software operation interface to achieve the similar purpose of the present invention. The various modifications and similar arrangements are covered by and included within the spirit and scope of the appended claims which are to be accorded with the broadest interpretation so as to encompass all such modifications and similar structures.

1. A multi-mode computer pointer, comprising:
a main body;
a function switch disposed on said main body and triggered to switch said computer pointer between a first mode and a second mode; and
a command generator in communication with said function switch and a computer, triggered in a manner to generate a frame/cursor control command to said computer in said first mode and triggered in the same manner to generate a media-player control command to said computer in said second mode.

2. The multi-mode computer pointer according to claim 1 wherein said function switch is a two-phase button pushed to generate a media-playing mode signal to have said computer pointer enter said second mode and further pushed to suspend said media-playing mode signal to have said computer pointer return to said first mode.

3. The multi-mode computer pointer according to claim 2 wherein a control signal is transmitted to said computer in said first mode to convey said frame/cursor control command, and said control signal is transmitted to said computer along with said media-playing mode signal in said second mode to convey said media-player control command.

4. The multi-mode computer pointer according to claim 1 wherein said command generator communicates with said computer via a windows interface, and said first and second commands are HID (human interface device) commands.

5. The multi-mode computer pointer according to claim 1 wherein said command generator comprises:
a plurality of control buttons disposed on said main body for generating control signals in response to the manipulation of the user; and
a wireless signal transmitter disposed on said main body for wirelessly transmitting said control signals to a wireless signal receiver of said computer to perform frame/cursor control in said first mode and wirelessly transmitting said control signals to said computer to perform media-player control in said second mode.

6. The multi-mode computer pointer according to claim 5 wherein said wireless signal transmitter further transmits a media-playing mode signal along with said control signals to said wireless signal receiver of said computer in said second mode.

7. The multi-mode computer pointer according to claim 6 wherein said wireless signal receiver coverts said control signals into said cursor control command and converts said media-playing mode signal and said control signals into said non-cursor control command.

8. The multi-mode computer pointer according to claim 1 being a mouse pointer.

9. The multi-mode computer pointer according to claim 1 being a trackball pointer.

10. A multi-mode computer pointer, comprising:
a main body;
a function switch disposed on said main body and triggered to switch said computer pointer between a first mode and a second mode; and
a command generator in communication with said function switch and a computer, triggered in a manner to generate a cursor control command to said computer in said first mode and triggered in the same manner to generate a non-cursor control command to said computer in said second mode.

11. The multi-mode computer pointer according to claim 10 wherein said non-cursor control command is for controlling an application program selected from a group consisting of Microsoft® windows media player, Microsoft® Office, Microsoft® Internet Explorer and Microsoft® Outlook application programs.

12. The multi-mode computer pointer according to claim 10 wherein said function switch is a two-phase button pushed to generate a non-cursor mode signal to have said computer pointer enter said second mode and further pushed to suspend said non-cursor mode signal to have said computer pointer return to said first mode.

13. The multi-mode computer pointer according to claim 12 wherein a control signal is transmitted to said computer in said first mode to convey said cursor control command, and said control signal is transmitted to said computer along with said non-cursor mode signal in said second mode to convey said non-cursor control command.

14. The multi-mode computer pointer according to claim 10 wherein said command generator communicates with said computer via a windows interface, and said first and second commands are HID (human interface device) commands.

15. The multi-mode computer pointer according to claim 10 wherein said command generator comprises:
a plurality of control buttons disposed on said main body for generating control signals in response to the manipulation of the user; and
a wireless signal transmitter disposed on said main body for wirelessly transmitting said control signals to a wireless signal receiver of said computer to perform cursor control in said first mode and wirelessly transmitting said control signals to said computer to perform non-cursor control in said second mode.

16. The multi-mode computer pointer according to claim 15 wherein said wireless signal transmitter further transmits a non-cursor mode signal along with said control signals to said wireless signal receiver of said computer in said second mode.

17. The multi-mode computer pointer according to claim 16 wherein said wireless signal receiver coverts said control signals into said first command and converts said non-cursor mode signal and said control signals into said second command.

18. A multi-mode computer mouse pointer, comprising:
a main body to be held by a user;
a two-phase function switch arranged on said main body, triggered to generate a mode-switching signal and further triggered to suspend said mode-switching signal; and
a plurality of control buttons arranged on said main body and clicked to generate control signals;
wherein said control signals are converted into a first control command with said mode-switching signal, and converted into a second control command without said mode-switching signal.

19. The multi-mode computer mouse pointer according to claim 18 wherein said first control command is a media-player control command and said second control command is a frame/cursor control command.

20. The multi-mode computer mouse pointer according to claim 19 wherein a plurality of icons are provided on said control buttons for identifying respective functions of said control buttons for media-player control.
